(19) United States
(12) Patent Application Publication
(10) Pub. No.: US 2011/0288763 A1
(43) Pub. Date: Nov. 24, 2011

(54) METHOD AND APPARATUS FOR DISPLAYING THREE-DIMENSIONAL ROUTE GUIDANCE

(75) Inventor: Alvin Hui, San Pedro, CA (US)

(73) Assignee: Alpine Electronics, Inc., Torrance, CA (US)

(21) Appl. No.: 12/781,986

(22) Filed: May 18, 2010

(51) Int. Cl. G01C 21/36; G08G 1/0969; G01S 19/42

(52) U.S. Cl. 701/201; 701/209

(57) ABSTRACT

This invention relates to a route displaying method and apparatus in a navigation system. More specifically, this invention relates to a navigation-based apparatus and method to display a complete route presented in three-dimension. The navigation system may include a map adjusting unit to adjust visual ground of the map for the user. In one embodiment, the map adjusting unit can adjust the visual ground area convexly, so that the user can view the full route including the destination. In another embodiment, the map adjusting unit may adjust the visual ground area concavely to present more surrounding details of the vehicle to the user. The navigation system may also include a wireless communication device to retrieve the most current map and traffic information from a remote server, and communicatively couple with the map adjusting unit and a route generating unit to provide the most updated information with full route view to the user. The navigation system may also be integrated into a portable device such as a smartphone.

### FIELD OF THE INVENTION

This invention relates to a route displaying method and apparatus in a navigation system. More specifically, this invention relates to a navigation-based apparatus and method to display a full route view in three-dimension.

### BACKGROUND OF THE INVENTION

Navigation devices, including portable navigation devices (PNDs), have become more popular and affordable recently for most users. The navigation device can, not only determine the user's current position by utilizing the Global Positioning System (GPS), but also provide different routing information between the vehicle's current position and the destination. In order to perform abovementioned functions, the navigation device is usually equipped with a sophisticated navigation system comprising navigation computer programs and one or more detailed database to store and provide maps, road networks, geographical features, and waypoint or point-of-interest (POI) information.

Generally, the navigation system generates a preferred or optimized route after receiving destination information input by the user and displays the route on a display unit. With remarkable advances in computer technology, there is a prevailing trend for three-dimensional (3D) display in the navigation devices since the 3D map output is more illustrative to provide better orientation and understanding of the route and the geographical features along the route than the two-dimensional (2D) display. The 3D map display may be more desirable when the map is presented on a large scale.

U.S. Pat. No. 6,285,317 to Ong discloses a navigation system for a mobile vehicle which incorporates a three-dimensional display updated with information from a wireless service provider, as shown in FIG. 1. Furthermore, the navigation system includes a real environment scene generator generating location pertinent information associated with a scene depicting the locality setting in a three dimensional format. Even though Ong teaches three-dimensional display, Ong does not disclose anything related to displaying a full route to the destination in a three-dimensional format.

U.S. Pat. No. 6,944,537 to Wiio et al. discloses a system to provide a three-dimensional route guidance service through a telecommunications network. Moreover, the system is to provide the user a service, by means of a three-dimensional virtual model representing the environment, how one moves in the real world from a given starting point to a given target point as shown in FIG. 2. Wiio also discloses the service in such a way that the quantity of data to be transmitted to the user workstation can be optimized as effectively as possible taking into account both the data transmission capacity of the telecommunications system and the storage and processing capacity of the user workstation. Like Ong, even Wiio discloses a three-dimensional model representing the environment, Wiio does not disclose anything associated with displaying the full route to the destination in a three-dimensional format.

U.S. Pat. No. 7,039,521 to Hortner et al. discloses a method and device is for displaying driving instructions. More particularly, when calculating the perspective view from the viewpoint of the user, the inclination of the vehicle about its longitudinal and lateral axes relative to the road surface is taken into account, as is the incline of the road or the three-dimensionality of the terrain, when generating overlaid driving instructions as illustrated in FIG. 3. However, like Ong and Wiio, Hortner does not disclose anything related to displaying the full route to the destination in a three-dimensional format.

Therefore, there remains a need for a new and improved route displaying system and method to display the full route in three-dimension including the vehicle's current location and the destination to provide better understanding of the route to the user.

### SUMMARY OF THE INVENTION

It is an object of the present invention to provide a method and apparatus to display a three-dimensional full route (including a destination) to a user without any “blind” spots, such that the user can have better understanding of the route while driving.

It is another object of the present invention to provide a full route visual presentation in three-dimension by adjusting a visual ground area convexly so that the full route can be viewed.

It is still another object of the present invention to provide local details around a vehicle's current position by adjusting the visual ground area concavely.

It is a further object of the present invention to provide a method and apparatus to transform a flat surface to convex/concave surface through a proper equation to adjust the scale of the map so that the three-dimensional full route can be shown, no matter how far the destination is located.

According to one aspect of the present invention, a navigation system comprises a user interface, a map adjusting unit; an information receiver adapted to receive information about current location of the user, for example, from a global positioning system (GPS); at least one database to store and provide maps, road networks, geographical features and POI information; and a route generating unit to retrieve the map and road network data from the database and generate a calculated route, wherein the map adjusting unit is communicatively coupled with the database and the route generating unit to change curvature of a visual ground in the map to provide route guidance in a three-dimensional format to the user.

In one embodiment, the map adjusting unit may convexly adjust a visual ground area so that the full route including the destination can be viewed. In another embodiment, the map adjusting unit may concavely adjust the visual ground area so as to provide more surrounding details of the vehicle to the user. In a further embodiment, the user interface including a display which may display the full route along with the geographical features, buildings and point-of-interests (POIs).

In still a further embodiment, the navigation system may further include a wireless communication device, which is adapted to retrieve most updated map and traffic information from a remote server, the Internet or other communication networks, is communicatively coupled with the map adjusting unit and the route generating unit to present the full route to the user with most updated information.

As to another aspect of the present invention, a method for providing a full route view in three-dimensional format may include the steps of loading map data from at least one database which is used to store and provide maps, road networks, geographical features and POI information; determining a vehicle's current position; determining a route from the vehicle's current position to a destination; and adjusting curvature of a visual ground in the map to provide better understanding of the route to the user.

In one embodiment, the step of adjusting curvature of a visual ground in the map may includes the step of convexly adjusting a visual ground area so that the full route including the destination can be viewed. In another embodiment, the step of adjusting curvature of a visual ground in the map may also include the step of concavely adjusting the visual ground area so as to provide more surrounding details of the vehicle to the user.

In a further embodiment, the method may further include the step of updating the map and traffic information through a wireless communication device, which is adapted to retrieve most updated map and traffic information from a remote server, the Internet or other communication networks. In still a further embodiment, the step of determining a vehicle's current position may include the step of receiving information about current location of the vehicle, for example, from a global positioning system (GPS).

The present invention together with the above and other advantages may best be understood from the following detailed description of the embodiments of the invention illustrated in the drawings below.

### BRIEF DESCRIPTION OF THE DRAWINGS

FIG. 1 illustrates a prior art, related to a navigation system for a mobile vehicle which incorporates a three-dimensional display updated with information from a wireless service provider

FIG. 2 illustrates a prior art, related to a system to provide a three-dimensional route guidance service through a telecommunications network.

FIG. 3 illustrates a prior art, related to a method and device is for displaying driving instructions in a three-dimensional format.

FIGS. 4a and 4b illustrate a traditional three-dimensional navigation displaying method with flat visual ground.

FIG. 5 illustrates a functional block diagram showing an example of structure of a navigation system implementing the method and apparatus in the present invention to provide better understanding of the route to the user in three-dimensional format.

FIGS. 6a and 6b illustrates two mathematical models of convex and concave surfaces, respectively.

FIG. 7 illustrates one embodiment of displaying the full route including the destination in the present invention.

FIG. 8 illustrates another embodiment of display local details around the vehicle in the present invention.

FIG. 9 illustrates a method for displaying route guidance in three-dimension in the present invention.

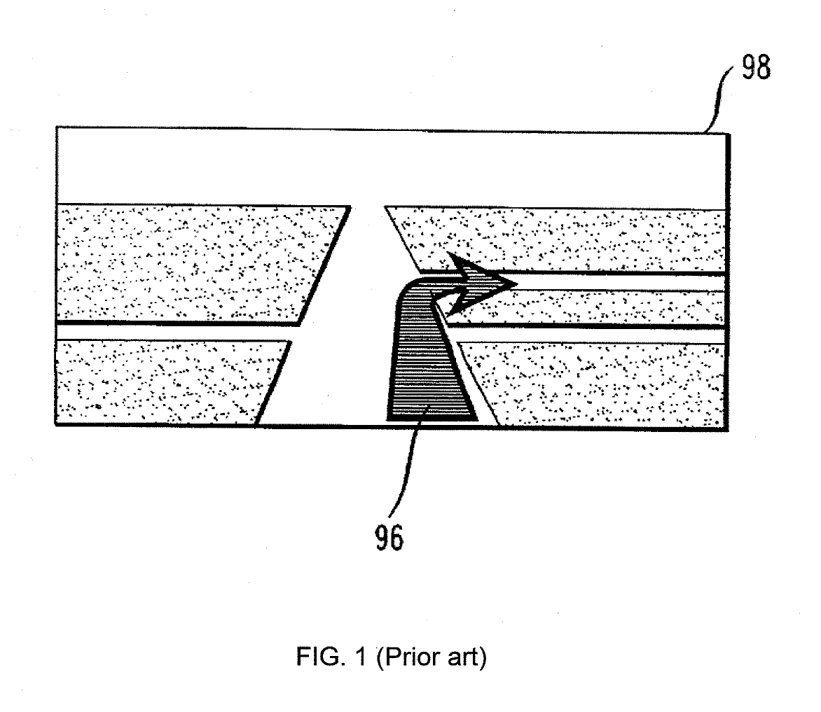

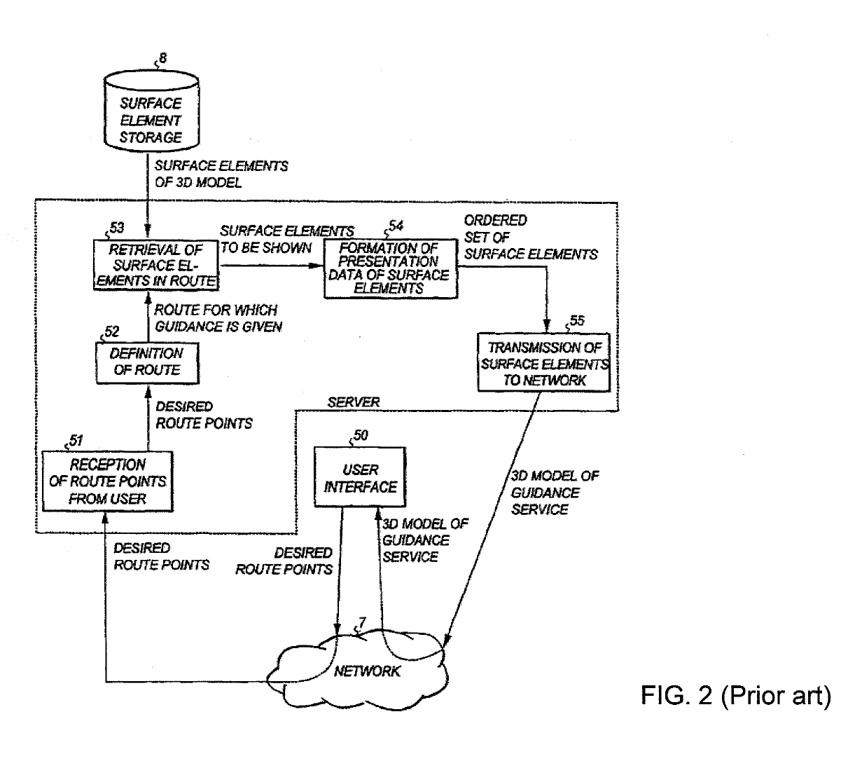

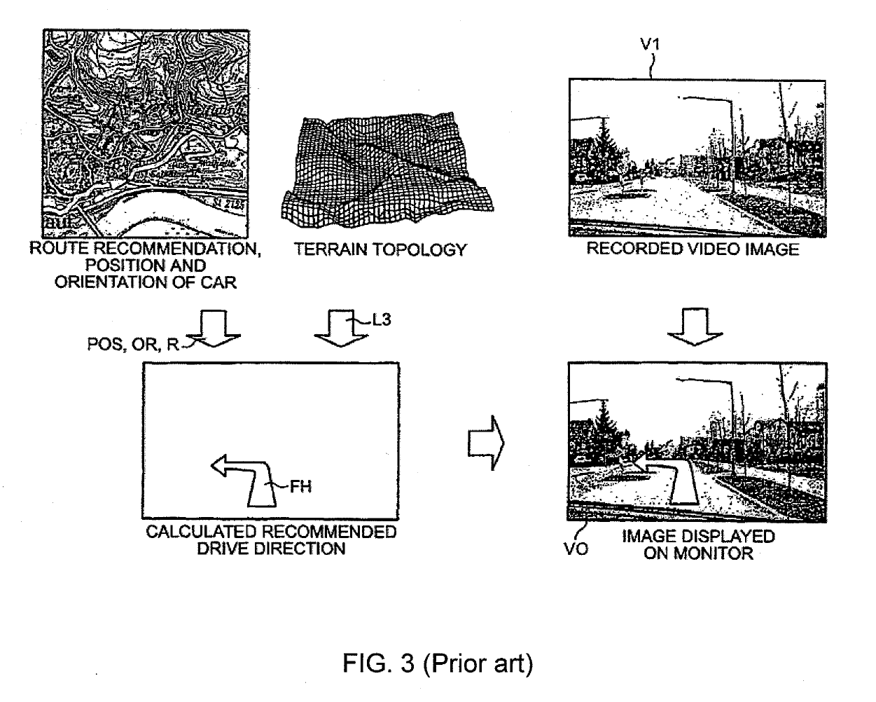

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

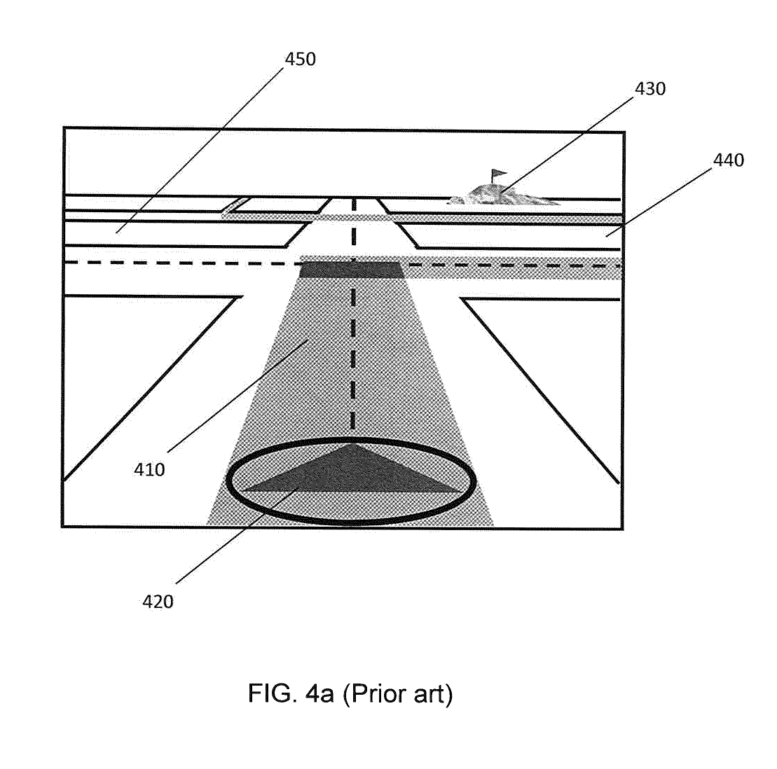

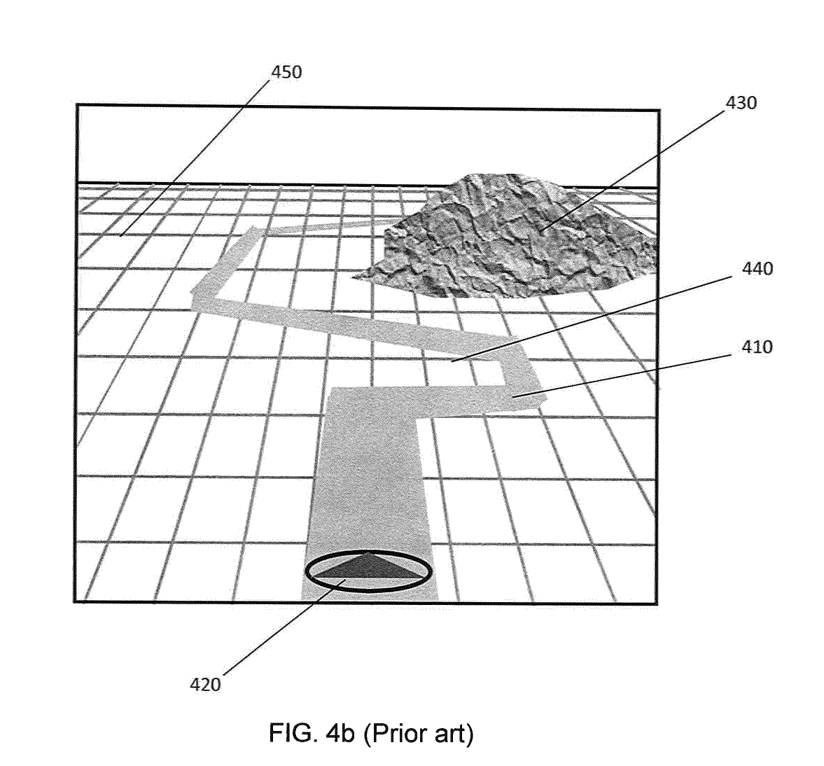

This invention relates to a route displaying method and apparatus in a navigation system. More specifically, this invention relates to a navigation-based apparatus and method to display a complete route presented in three-dimension. Currently, many navigation systems provide three-dimensional (3D) instead of traditional two-dimensional (2D) route guidance since three-dimensional map output is more illustrative to provide better orientation and understanding of the route and geographical features along the route. For example, as can be seen in FIG. 4a, the 3D map presentation may include a calculated route 410 and a geographical feature 430. Comparing to the 2D route guidance, the user may have better understanding of the environment near a vehicle's current position 420 and along the route 410 in the 3D route presentation.

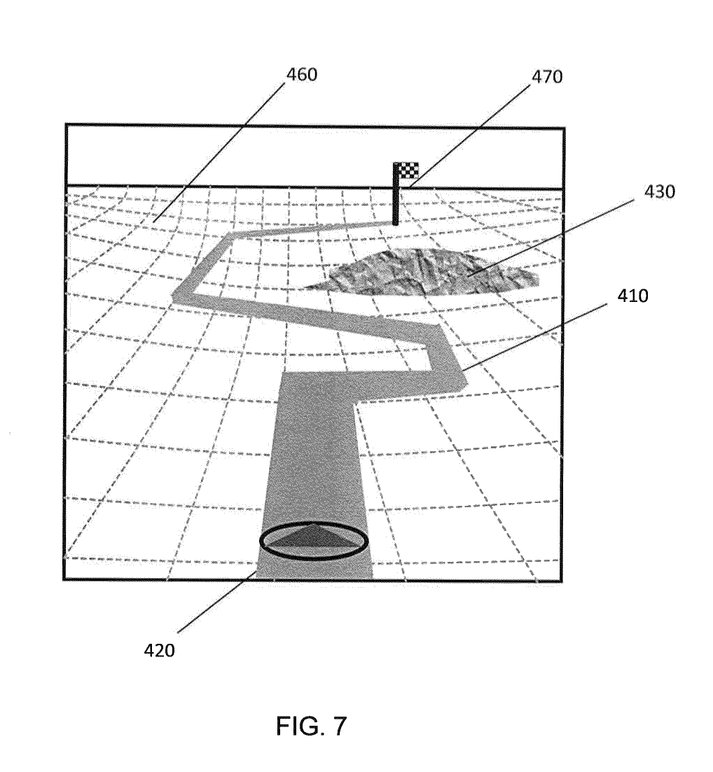

However, even the 3D route guidance is more illustrative than the 2D guidance, some “blind” spots may still exist in the 3D route guidance. For example, as can be seen in FIG. 4a, the driver may not be able to see the detail route or the geographical feature(s) at a corner 440 from the vehicle's current position 420. Even the driver can adjust the angle of the visual ground to see the corner 440 in FIG. 4b, it may still be difficult for the driver to see the full route including the destination. Therefore, there remains a need for a new and improved route displaying method to transform the visual ground of the route guidance from a flat surface 450 to a convex surface 460 (shown in FIG. 7) to provide a full route view including the destination to the driver.

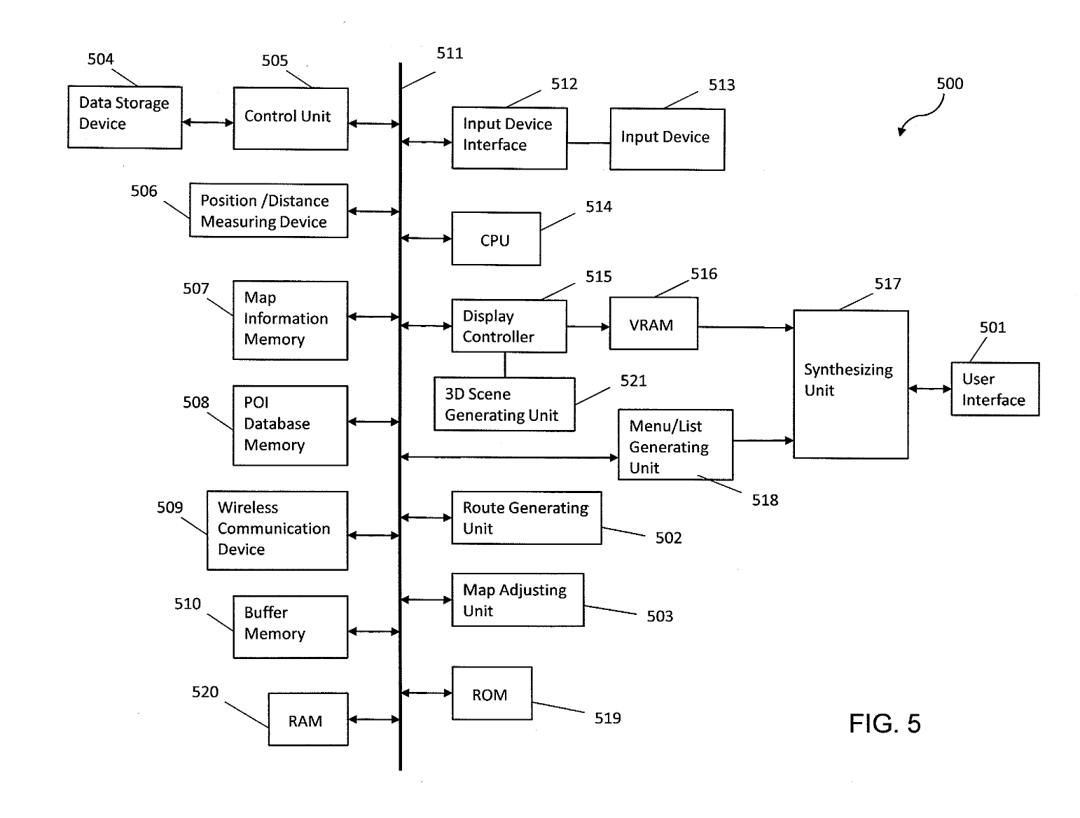

FIG. 5 is a block diagram showing an example of structure of a navigation system 500 for implementing the present invention. The navigation system 500 includes a user interface 501, a route generating unit 502 to retrieve map and road network data and generate a calculated route, and a map adjusting unit 503 to adjust visual ground of the map for the user. In one embodiment, the map adjusting unit 503 can adjust the visual ground area convexly, so that the user can view the full route in three-dimension including the destination. In another embodiment, the map adjusting unit 503 may adjust the visual ground area concavely to present more surrounding details of the vehicle to the user in three-dimension. In a further embodiment, the user interface 501 is a display unit which is configured to display maps, POIs and routing information.

The system also includes a data storage device 504 such as a hard disc, CD-ROM, DVD or other storage means for storing the map data; a control unit 505 for controlling an operation for reading the information from the data storage device 504; and a position and distance measuring device 506 for measuring the present vehicle position or user position. For example, the position and distance measuring device 506 has a speed sensor for detecting a moving distance, a gyroscope for detecting a moving direction, a microprocessor for calculating a position, a GPS (global positioning system) receiver for receiving GPS signals from satellites for calculating a current position of the user. In one embodiment, the POI searching unit 502 is communicatively coupled with the position and distance measuring device 506 to receive the current position of the user. In another embodiment, the navigation system 500 may be integrated into a portable device, such as portable navigation devices (PNDs) or smartphones.

The block diagram of FIG. 5 further includes a map information memory 507 for storing the map information which is read from data storage 504, a database memory 508 for storing database information such a point of interest (POT) information which is read out from the data storage device 504, an input device 513 for executing a menu selection operation, an enlarge/reduce operation, a destination input operation, etc. and an input device interface 512. In one embodiment, the input device 513 is a remote controller.

Still referring to FIG. 5, the navigation system 500 includes a bus 511 for interfacing the above units in the system, a processor (CPU) 514 for controlling an overall operation of the navigation system 500, a ROM 519 for storing various control programs such as a route search program and a map matching program necessary for navigation control, a RAM 520 for storing a processing result such as a guide route, a display controller 515 for generating map image (a map guide image and an arrow guide image) on the basis of the map information, a VRAM 516 for storing images generated by the display controller 515, a menu/list generating unit 518 for generating menu image/various list images, a synthesizing unit 517, a wireless communication device 509 to retrieve data from a remote server, the Internet or other communication networks, and a buffer memory 510 for temporary storing data for ease of data processing. In one embodiment, the display controller 515 may include a three-dimensional (3D) scene generating unit 521 adapted to generate the three-dimensional scene from two-dimensional scene information.

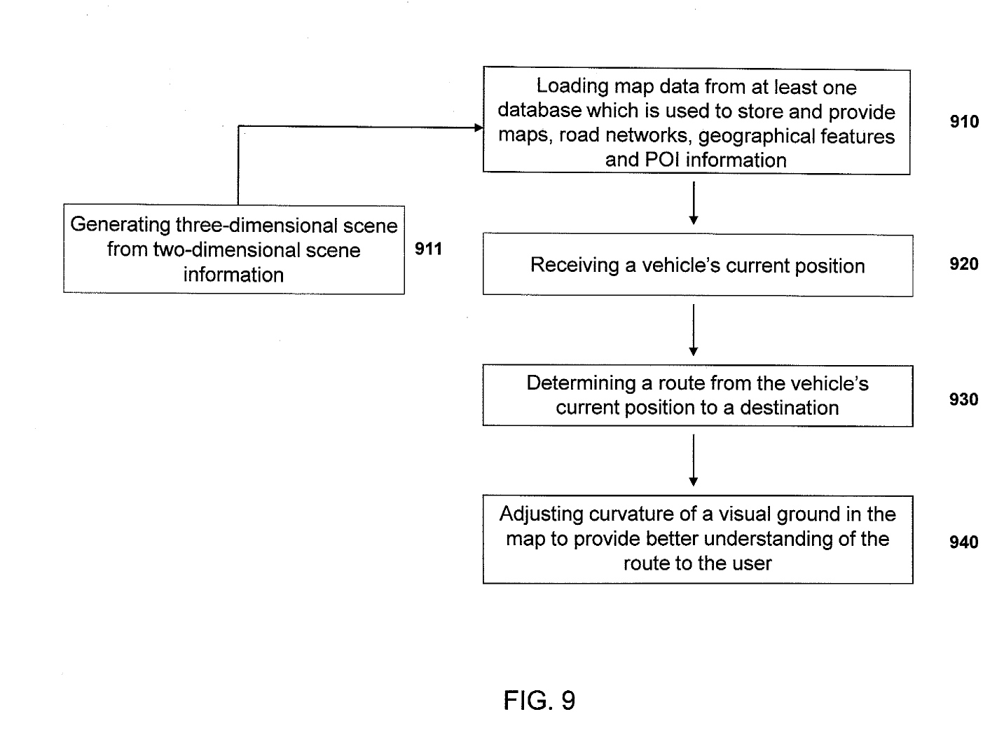

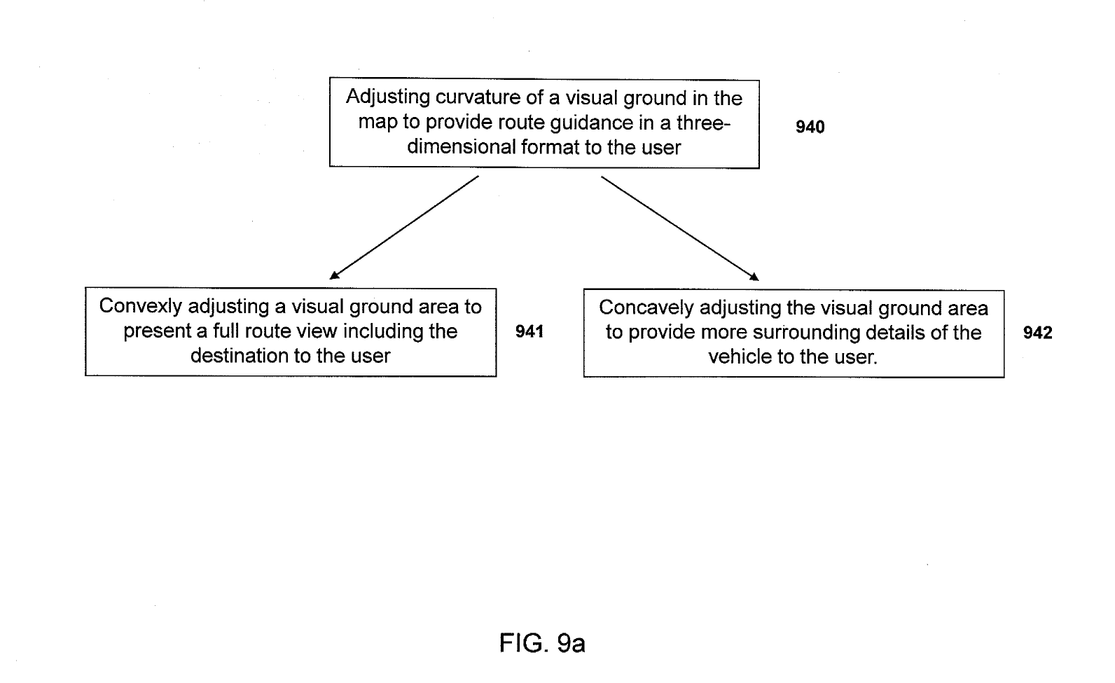

A program for providing a full route view in the present invention shown in the flow charts of FIG. 9 is stored in the ROM 519 or other memory and is executed by the CPU 514. The CPU 514 controls an overall operation of the navigation system including the method and apparatus to change curvature of a visual ground in the map to provide route guidance in a three-dimensional format to the user.

In one embodiment, the route generating unit 502 can retrieve the map information from the Map Information Memory 507. In another embodiment, the route generating unit 502 can be communicatively coupled with the map adjusting unit 503 and the wireless communication device 509 to retrieve the most current map and traffic information from (but not limited to) a remote server and provide the most updated (traffic, weather, etc.) information along with the full route view to the user.

In an exemplary embodiment, the map adjusting unit 503 is communicatively coupled with the display controller 515 (including the 3D scene generating unit 521) to generate the three-dimensional map image illustrating the full route including the destination, as shown in FIG. 7. More specifically, the map adjusting unit 503 transforms the flat visual ground 450 to the convex visual ground 460 and the display controller 515 is adapted to generate such map image to provide the full route 410 including the vehicle's current position 420 and a destination 470.

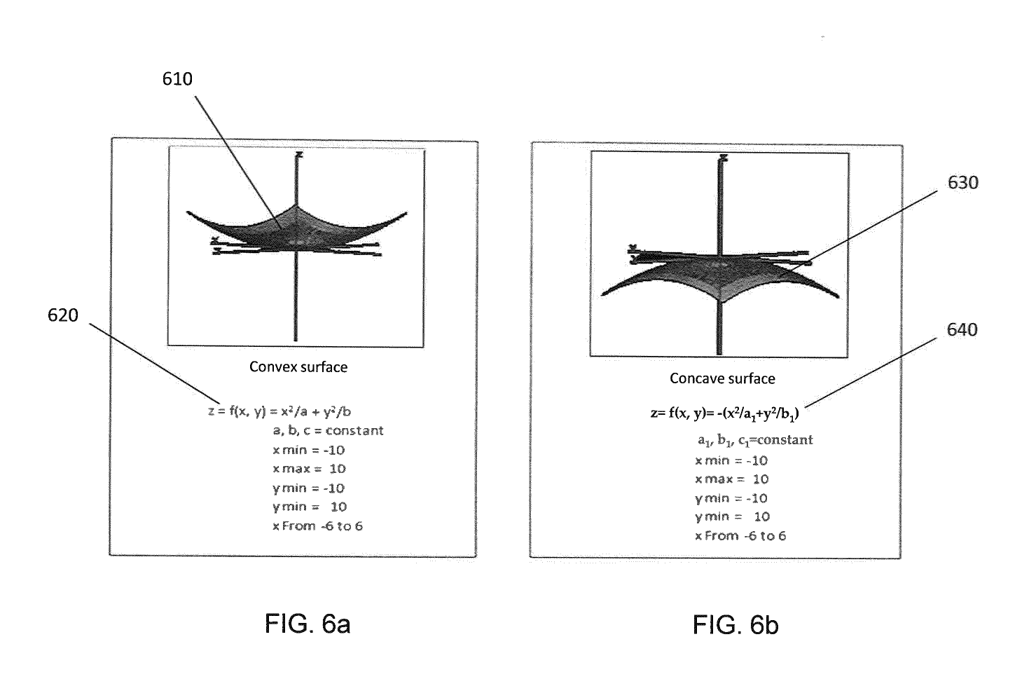

It is noted that the full route view in FIG. 7 can always be shown to the user no matter how far the destination is located since the curvature of the convex surface 460 can be adjusted by changing certain parameters in a mathematical model. For example, as illustrated in FIG. 6a, a convex surface 610 can be defined by an equation 620, and the curvature of the convex surface 610 can be adjusted by changing parameters “a” and “b”.

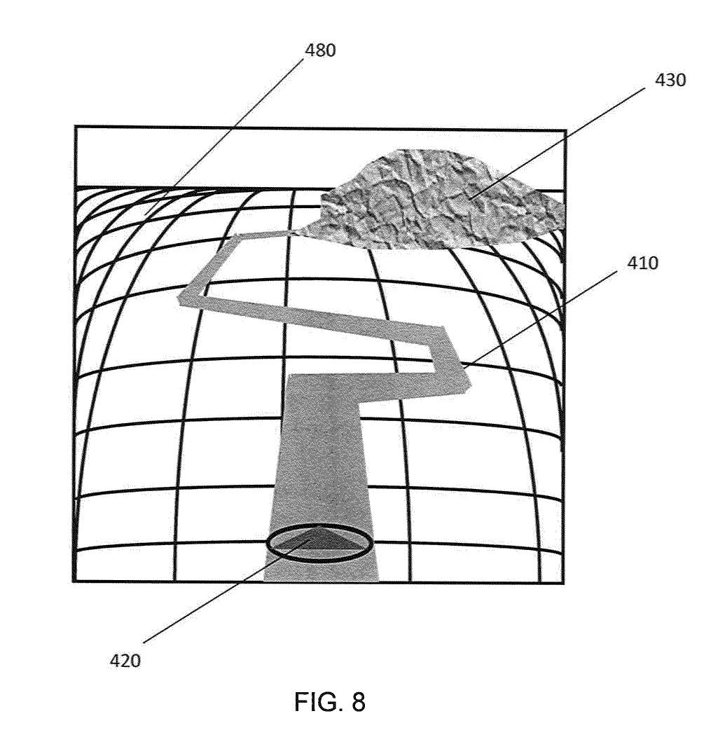

Likewise, the curvature of a concave surface 480 in FIG. 8 can also be adjusted in the same manner. For example, the curvature of a concave surface 630 can be adjusted by changing parameters “a₁” and “b₁” in an equation 640 in FIG. 6b. In one embodiment, the equations 620 and 640 may be integrated into the map adjusting unit 503 which is configured to adjust the curvature of the convex/concave surfaces in the present invention.

According to another aspect of the present invention illustrated in FIG. 9, a method for providing a full route in three-dimensional format may include the steps of loading map data from at least one database which is used to store and provide maps, road networks, geographical features and POI information 910; determining a vehicle's current position 920; determining a route from the vehicle's current position to a destination 930; and adjusting curvature of a visual ground in the map to provide route guidance in a three-dimensional format to the user 940. In one embodiment, the step of loading map data from at least one database 910 may include the step of generating three-dimensional scene from two-dimensional scene information 911.

In another embodiment shown in FIG. 9a, the step of adjusting curvature of a visual ground in the map 940 may includes the step of convexly adjusting a visual ground area 941, so that the full route including the destination can be viewed. In still another embodiment, the step of adjusting curvature of a visual ground in the map may also include the step of concavely adjusting the visual ground area 942, so as to provide more surrounding details of the vehicle to the user.

In a further embodiment, the method may further include the step of updating the map and traffic information through a wireless communication device 950, which is adapted to retrieve most updated map and traffic information from a remote server, the Internet or other communication networks. In still a further embodiment, the step of determining a vehicle's current position 930 may include the step of receiving information about current location of the vehicle, for example, from a global positioning system (GPS) 931.

Having described the invention by the description and illustrations above, it should be understood that these are exemplary of the invention and are not to be considered as limiting. Accordingly, the invention is not to be considered as limited by the foregoing description, but includes any equivalents.

1. A navigation system comprises:
a user interface including a three-dimensional scene generating unit adapted to generate the three-dimensional scene from two-dimensional scene information;
an information receiver adapted to receive information about current location of a user;
at least one database to store and provide maps, road networks, geographical features, and point-of-interest (POI) information;
a route generating unit to retrieve the map and road network data from the database and generate a calculated route; and
a map adjusting unit,
wherein the map adjusting unit is communicatively coupled with the database and the route generating unit to change curvature of a visual ground in the map to provide route guidance in a three-dimensional format to the user.

2. The navigation system of claim 1, wherein the map adjusting unit convexly adjusts the visual ground in the map to present a full route view including a destination to the user.

3. The navigation system of claim 2, wherein said map adjusting unit is adapted to adjust the curvature of the convex surface to present the full route no matter how far the destination is located.

4. The navigation system of claim 1, further comprises a wireless communication device, which is adapted to retrieve most updated map and traffic information from a remote server, the Internet or other communication networks, is communicatively coupled with the map adjusting unit and the route generating unit to present the full route to the user with most updated information.

5. The navigation system of claim 1, wherein the map adjusting unit concavely adjusts the visual ground in the map to provide local details around a vehicle's position to the user.

6. The navigation system of claim 3, wherein the three-dimensional scene generating unit is communicatively coupled with the map adjusting unit and the route generating unit to generate the three-dimensional full route view.

7. A method for providing three-dimensional route guidance to a user comprises the steps of:
loading map data from at least one database which is used to store and provide maps, road networks, geographical features and POI information;
determining a vehicle's current position;
determining a route from the vehicle's current position to a destination;
adjusting curvature of a visual ground in the map to provide route guidance in a three-dimensional format to the user.

8. The method of claim 7, wherein the step of adjusting curvature of a visual ground in the map comprises the step of convexly adjusting a visual ground area to present a full route view including the destination to the user.

9. The method of claim 7, wherein the step of adjusting curvature of a visual ground in the map comprises the step of concavely adjusting the visual ground area to provide more surrounding details of the vehicle to the user.

10. The method of claim 7 further comprises the step of updating the map and traffic information through a wireless communication device, which is adapted to retrieve most updated map and traffic information from a remote server, the Internet or other communication networks.

11. The method of claim 7, wherein the step of determining a vehicle's current position comprises the step of receiving information about current location of the vehicle, for example, from a global positioning system (GPS).

12. The method of claim 8, wherein the step of adjusting curvature of a visual ground in the map further comprises the step of adjusting the curvature of the convex surface to present the full route no matter how far the destination is located.

13. The method of claim 7, wherein the step of loading map data from at least one database comprises the step of generating three-dimensional scene from two-dimensional scene information.

14. A smartphone comprising:
a user interface including a three-dimensional scene generating unit adapted to generate the three-dimensional scene from two-dimensional scene information;
a memory device;
a control unit; and
a navigation system comprising:
an information receiver adapted to receive information about current location of a user;
at least one database to store and provide maps, road networks, geographical features, and point-of-interest (POI) information;
a route generating unit to retrieve the map and road network data from the database and generate a calculated route; and
a map adjusting unit,
wherein the control unit is configured to receive route information from the route generating unit and instruct the map adjusting unit to change curvature of a visual ground in the map to display route guidance in a three-dimensional format on the user interface.

15. The smartphone of claim 14, wherein the map adjusting unit convexly adjusts the visual ground in the map to present a full route view including a destination to the user.

16. The smartphone of claim 15, wherein said map adjusting unit is adapted to adjust the curvature of the convex surface to present the full route no matter how far the destination is located.

17. The smartphone of claim 14, wherein the map adjusting unit concavely adjusts the visual ground in the map to provide local details around a vehicle's position to the user.

18. The smartphone of claim 14, further comprises a wireless communication device, which is adapted to retrieve most updated map and traffic information from a remote server, the Internet or other communication networks, is communicatively coupled with the map adjusting unit and the route generating unit to present the full route to the user with most updated information.

19. The smartphone of claim 16, wherein the three-dimensional scene generating unit is communicatively coupled with the map adjusting unit and the route generating unit to generate the three-dimensional full route view.
